(19) United States
(12) Patent Application Publication
(10) Pub. No.: US 2026/0179611 A1
(43) Pub. Date: Jun. 25, 2026

(54) AI-POWERED CONTEXTUAL LIVE QUESTION AND ANSWER WHEN RENDERING PRE-PRODUCED AUDIO CONTENT

(71) Applicant: Microsoft Technology Licensing, LLC, Redmond, WA (US)

(72) Inventors: Priyankar KUMAR, New Delhi (IN); Vishnu GOGULA, Noida (IN); Shourya Raj MEHROTRA, Faridabad (IN); Sanjib BISWAS, New Delhi (IN); Abhishek AGARWAL, Saharanpur (IN); Ashish SRIVASTAVA, Noida (IN); Akul TANEJA, New Delhi (IN); Ankit SHARMA, Faridabad (IN); Ankit JAIN, Panchkula (IN)

(73) Assignee: Microsoft Technology Licensing, LLC, Redmond, WA (US)

(21) Appl. No.: 18/987,747

(22) Filed: Dec. 19, 2024

(51) Int. Cl. G10L 15/22; G06F 3/16; G10L 13/08; G10L 15/26

(52) U.S. Cl. CPC G10L 15/22; G06F 3/165; G10L 13/08; G10L 15/26

(57) ABSTRACT

A data processing system implements causing a user interface of a client device to render pre-produced audio content; receiving via a an audio receiver of the client device a user query raised during a portion of the pre-produced audio content being rendered on the user interface; causing the user interface to pause the pre-produced audio content in response to receiving the user query; automatically generating a text transcript of the user query using speech recognition; calling a generative model to generate a contextual text answer to the user query based on the text transcript, the portion of the pre-produced audio content, and at least rendered portions of the pre-produced audio content; converting the contextual text answer into an audio answer using voice synthesis; causing the user interface to render the audio answer on the client device; and causing the user interface to resume the pre-produced audio content.

### BACKGROUND

Modern life is busy and demanding with many different types of personal and work information. Daily content consumption is a powerful tool for both learning and working. Common strategies to improve the time required for content consumption include audio content consumption while performing other tasks such as commuting, exercising, cooking, and the like. Artificial intelligence (AI) has been used to automate our lives to save time and increase productivity. However, the existing AI-powered audio content consumption solutions do not support contextual live question and answer (Q&A) when rendering pre-produced audio content. While such audio content is useful for many users, the users need to manually search online for further information if they have questions regarding the rendered audio content, which is time consuming. Hence, there is a need for providing systems and methods of AI-powered contextual live questions and answers (Q&A) when rendering pre-produced audio content.

### SUMMARY

An example data processing system according to the disclosure includes a processor and a machine-readable medium storing executable instructions. The instructions when executed cause the processor alone or in combination with other processors to perform operations including causing a user interface of a client device to render pre-produced audio content; receiving via a an audio receiver of the client device a user query raised during a portion of the pre-produced audio content being rendered on the user interface; causing the user interface to pause the pre-produced audio content on the client device in response to receiving the user query; automatically generating a text transcript of the user query using speech recognition; calling a generative model to generate a contextual text answer to the user query based on the text transcript of the user query, the portion of the pre-produced audio content, and at least rendered portions of the pre-produced audio content; converting the contextual text answer into an audio answer using voice synthesis; causing the user interface to render the audio answer on the client device; and causing the user interface to resume the pre-produced audio content after the audio answer is rendered.

An example method implemented in a data processing system includes causing a user interface of a client device to render pre-produced audio content; receiving via a an audio receiver of the client device a user query raised during a portion of the pre-produced audio content being rendered on the user interface; causing the user interface to pause the pre-produced audio content on the client device in response to receiving the user query; automatically generating a text transcript of the user query using speech recognition; calling a generative model to generate a contextual text answer to the user query based on the text transcript of the user query, the portion of the pre-produced audio content, and at least rendered portions of the pre-produced audio content; converting the contextual text answer into an audio answer using voice synthesis; causing the user interface to render the audio answer on the client device; and causing the user interface to resume the pre-produced audio content after the audio answer is rendered.

An example non-transitory computer readable medium data processing system according to the disclosure on which are stored instructions that, when executed, cause a programmable device to perform functions of causing a user interface of a client device to render pre-produced audio content; receiving via a an audio receiver of the client device a user query raised during a portion of the pre-produced audio content being rendered on the user interface; causing the user interface to pause the pre-produced audio content on the client device in response to receiving the user query; automatically generating a text transcript of the user query using speech recognition; calling a generative model to generate a contextual text answer to the user query based on the text transcript of the user query, the portion of the pre-produced audio content, and at least rendered portions of the pre-produced audio content; converting the contextual text answer into an audio answer using voice synthesis; causing the user interface to render the audio answer on the client device; and causing the user interface to resume the pre-produced audio content after the audio answer is rendered.

An example data processing system according to the disclosure includes a processor and a machine-readable medium storing executable instructions. The instructions when executed cause the processor alone or in combination with other processors to perform operations including causing a user interface of a client device to render pre-produced serially consumable digital content, wherein the digital content includes video content and audio content; receiving via a an audio receiver of the client device a user query raised during a portion of the pre-produced digital content being rendered on the user interface; causing the user interface to pause the pre-produced digital content on the client device in response to receiving the user query; automatically generating a text transcript of the user query using speech recognition; calling a generative model to generate a contextual text answer to the user query based on the text transcript of the user query, the portion of the pre-produced digital content, and at least rendered portions of the pre-produced digital content; converting the contextual text answer into a multimedia answer using voice and image synthesis; causing the user interface to render the multimedia answer on the client device; and causing the user interface to resume the pre-produced digital content after the multimedia answer is rendered.

An example method implemented in a data processing system includes causing a user interface of a client device to render pre-produced serially consumable digital content, wherein the digital content includes video content and audio content; receiving via a an audio receiver of the client device a user query raised during a portion of the pre-produced digital content being rendered on the user interface; causing the user interface to pause the pre-produced digital content on the client device in response to receiving the user query; automatically generating a text transcript of the user query using speech recognition; calling a generative model to generate a contextual text answer to the user query based on the text transcript of the user query, the portion of the pre-produced digital content, and at least rendered portions of the pre-produced digital content; converting the contextual text answer into a multimedia answer using voice and image synthesis; causing the user interface to render the multimedia answer on the client device; and causing the user interface to resume the pre-produced digital content after the multimedia answer is rendered.

An example non-transitory computer readable medium data processing system according to the disclosure on which are stored instructions that, when executed, cause a programmable device to perform functions of causing a user interface of a client device to render pre-produced serially consumable digital content, wherein the digital content includes video content and audio content; receiving via a an audio receiver of the client device a user query raised during a portion of the pre-produced digital content being rendered on the user interface; causing the user interface to pause the pre-produced digital content on the client device in response to receiving the user query; automatically generating a text transcript of the user query using speech recognition; calling a generative model to generate a contextual text answer to the user query based on the text transcript of the user query, the portion of the pre-produced digital content, and at least rendered portions of the pre-produced digital content; converting the contextual text answer into a multimedia answer using voice and image synthesis; causing the user interface to render the multimedia answer on the client device; and causing the user interface to resume the pre-produced digital content after the multimedia answer is rendered.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for providing AI-powered contextual live Q&A when rendering pre-produced audio content are implemented.

FIG. 2A is a conceptual diagram of a workflow for AI-powered contextual live Q&A when rendering pre-produced audio content of the system of FIG. 1 according to principles described herein.

FIG. 2B is a conceptual diagram of AI-powered audio content production and voice synthesis of the system of FIG. 1 according to principles described herein.

FIGS. 2C-2D is a sequence diagram of a workflow for AI-powered audio content production and contextual live Q&A when rendering the audio content of the system of FIG. 1 according to principles described herein.

FIGS. 3A-3C are diagrams of example user interfaces of an AI-based content generation application that implements the techniques described herein.

FIG. 4 is a flow chart of an example process for providing AI-powered contextual live Q&A when rendering pre-produced audio content according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

Systems and methods for using generative AI for audio answer generation of content are described herein. These techniques provide a technical solution to the technical problems of providing live and contextual answers to user queries directed to just rendered or interrupted pre-produced audio content. There are many AI-powered audio content generation systems (e.g., NotebookLM®) that play the generated audio content as is, without any built-in Q&A mechanisms. A user with questions about being rendered audio content needs to search online or call a voice AI chatbot (e.g., Alexa, Siri, Google Assistant, and the like) to get answers, which is time consuming. In addition, a voice AI chatbot offers live Q&A directly based on the user's questions, but not directly based on the just rendered or interrupted pre-produced audio segment.

On the other hand, some existing AI-powered audio content consumption solutions (e.g., language lessons) respond to a user query with a scripted answer. In such case, there are only scripted Q&A, instead of live Q&A.

To address these issues, the inventors create a workflow for AI-powered contextual live Q&A when rendering pre-produced audio content, which not only saves users' time to consume the rendered audio content, but also increases users' understanding of the audio content with additional information obtained via live Q&A. The proposed workflow improves AI-powered audio content consumption solutions by applying a generative model (e.g., LLM) to generate a highly contextual answer to a user query addressed to an audio segment of a pre-produced audio content item just rendered or interrupted, playing the contextual answer to the user while pausing pre-produced audio content item, and then resuming the pre-produced audio content item after playing the contextual answer.

The workflow can automatically retrieve additional information directed to the user query and the just rendered or interrupted audio segment(s), and then convert the contextual text answer into an audio answer in the voice of a speaker in the last rendered audio segment. In one implementation, the workflow pre-trains a generative model for each speaker in the pre-produced audio content. In repose to the user query, the system extracts voice identifier (ID) of the interrupted audio segment, and converts the contextual answer into an audio answer using the pre-trained voice synthesis generative model based on the voice ID.

The workflow thus provides contextual information to answer user's question during audio play. The key feature is that the answer is provided in a natural way considering not only about the content but also the flow of the audio play, where the pause point is also analyzed and hence to make the resume more natural and smoother.

A technical benefit of the approach provided herein is to allow a user to converse (e.g., Q&A) live with a speaker AI in an pre-produced audio content item when the user is consuming the audio content item. The approach thus improves the interactivity of AI-generated audio content consumption and enhances user engagement and satisfaction.

Another technical benefit of this approach is to provide such conversion sounding naturally as if conversing with the voices in the audio content, based on a voice synthesis model pre-trained using the speaker's voice data.

Another technical benefit of this approach is to include the user query and the audio answer in the audio content for later use or publication.

Another technical benefit of this approach is applying the workflow to provide AI-powered contextual live Q&A when rendering pre-produced video content. For example, a large vision generative model (e.g., Sora) can be applied to efficiently and creatively generate video clips of the user speaking the user query and the speaker speaking the audio answer to include in the video content.

Yet, another technical benefit of this approach is providing user interfaces that allow users to interact with the system to edit the audio content, provide feedback, and re-generate audio answers of the content based on the feedback. These and other technical benefits of the techniques disclosed herein will be evident from the discussion of the example implementations that follow.

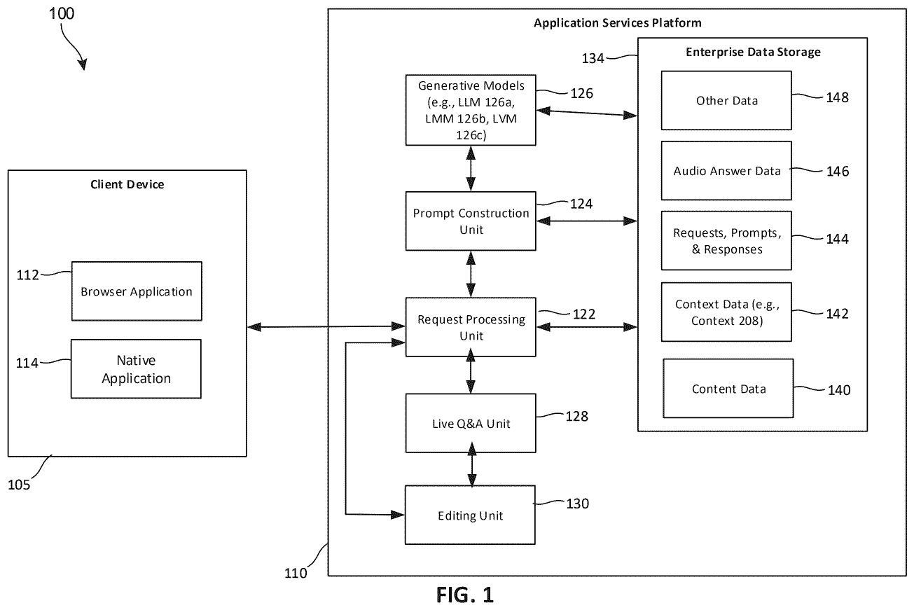

FIG. 1 is a diagram of an example computing environment 100 in which the techniques herein may be implemented. The example computing environment 100 includes a client device 105 and an application services platform 110. The application services platform 110 provides one or more cloud-based applications and/or provides services to support one or more web-enabled native applications on the client device 105. These applications may include but are not limited to audio content generation applications, presentation applications, website authoring applications, collaboration platforms, communications platforms, and/or other types of applications in which users may create, play, and/or modify audio content. In the implementation shown in FIG. 1, the application services platform 110 also applies generative AI to generate fast and concise audio content upon user demand, according to the techniques described herein. For instance, the user asks the AI to generate a 20-minute podcast episode on “Marine Pollution” via conversations of two AI-generated hosts, based on the user's recently published article.

In one implementation, the application services platform 110 is independently implemented on the client device 105. In another implementation, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a client device 105, other implementations may include a different number of client devices that utilize services provided by the application services platform 110.

As used herein, the term “content” refers to any information that exists in a format that can be processed by computers. Examples include text documents, images, audio files, videos, software applications, websites, social media posts, and the like. Although various implementations are described with respect to audio content, it is contemplated that the approach described herein may be used any content embedded with audio content (e.g., video content, social media posts, blog posts, articles, or newsletters embedded with audio segments, and the like).

The term “contextual” refers to anything that is related to or determined by the context. It focuses on the setting or environment in which something occurs. For instance, a “contextual answer” refers to a answer based on a user query, the content or context of the audio content segment just being rendered, and the content of the audio content, without considering the individual user's characteristics.

The term “pre-produced audio content” refers to the audio content that has finalized content (e.g., in program language like speech synthesis markup language, SSML) before any user's demand of playing audio content. Such pre-produced audio content can be converted into audio signals per dialog on demand.

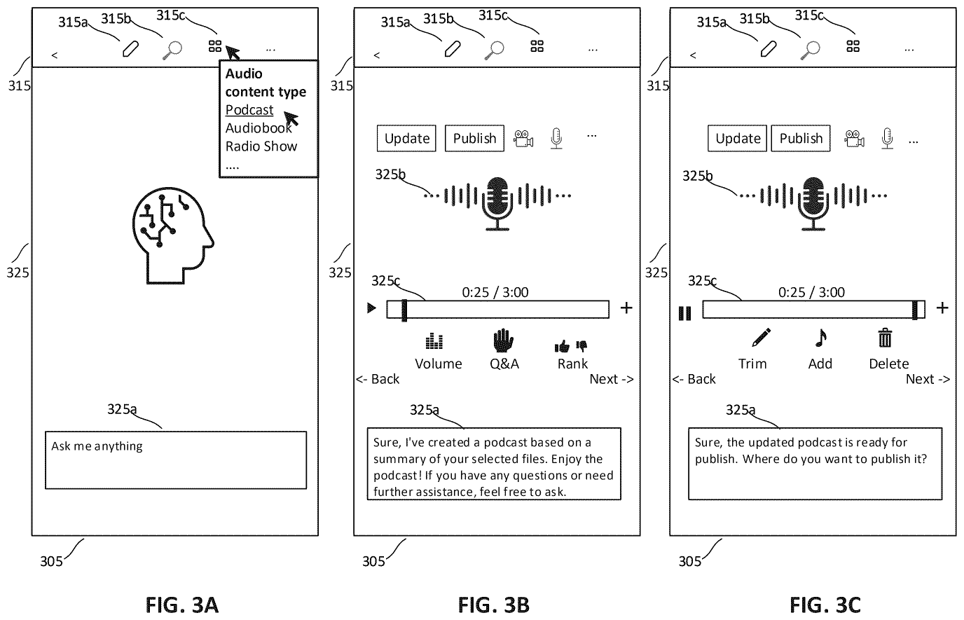

The client device 105 includes a native application 114 and a browser application 112. The native application 114 is a web-enabled native application, in some implementations, which enables users to create, play, and/or modify audio content. The web-enabled native application utilizes services provided by the application services platform 110 including but not limited to creating, playing, and/or modifying various types of audio content and obtaining content data source(s) for creating, playing, and/or modifying the audio content. The native application 114 implements a user interface 305 shown in FIGS. 3A-3C in some implementations. In other implementations, the browser application 112 is used for accessing and viewing web-based content provided by the application services platform 110. In such implementations, the application services platform 110 implements one or more web applications, such as the browser application 112, that enables users to create, play, and/or modify audio content and to obtain content data for creating live audio answers in response to a user query when rendering pre-produced audio content. The browser application 112 implements the user interface 305 shown in FIGS. 3A-3C in some implementations. The application services platform 110 supports both the native application 114 and the browser application 112 in some implementations, and the users may choose which approach best suits their needs.

In one implementation, the application services platform 110 includes a request processing unit 122, a prompt construction unit 124, generative models 126, a live Q&A unit 128, and an editing unit 130. In other implementations, the application services platform 110 also includes an enterprise data storage 134, and moderation services (not shown).

The request processing unit 122 is configured to receive requests from the native application 114 and/or the browser application 112 of the client device 105. The requests may include but are not limited to requests to create, play, and/or modify various types of audio content and/or sending natural language prompts to a generative model (e.g., the LLM 126a) to generate a live audio answer to a user query when rendering an audio segment of the pre-produced audio content that is just rendered or interrupted according to the techniques provided herein. The request processing unit 122 also coordinates communication and exchange of data among components of the application services platform 110 as discussed in the examples which follow.

In one implementation, the generative models 126 include a generative model trained to generate content (e.g., textual, spreadsheet, chart, report, audio, image, video, and the like) in response to natural language prompts input by a user via the native application 114 or via the web. For instance, the generative models 126 are implemented using a large language model (LLM) or a large multimodal model (LMM) in some implementations. Examples of such models include but are not limited to a Generative Pre-trained Transformer 4 (GPT-4), GPT-40, and the like. Developing an AI model capable of accurately summarizing content in digital content requires training on large and diverse datasets, thereby ensuring that the generated contextual relevant answers to a user query and a just-rendered audio segment of the pre-produced audio content. Other implementations may utilize machine learning models or other generative models to generate a live audio answer to a user query when rendering an audio segment of the pre-produced audio content that is just rendered or interrupted according to contextual features of the content and/or preferences of a user. In terms of video answers, the system can leverage Sora or similar models, and ground them with relevant data.

In one scenario, the workflow for AI-powered contextual live Q&A when rendering pre-produced audio content can create an audio answer on an AI platform (e.g., Microsoft 365 Copilot®) that enables users to understand the audio content, like audiobooks, podcasts, or talk shows. When playing such pre-produced audio content, a user of the system can invoke a “live Q&A” functionality from an AI interface (either from a voice chat or from a contextual user interface), to ask a question via a microphone of the like of the client device 105 and get a live answer based on the question and a just-rendered audio segment of the pre-produced audio content. The request processing unit 122 receives a user question/query from the native application 114 or the browser application 112 that hosts the voice chat or the contextual user interface.

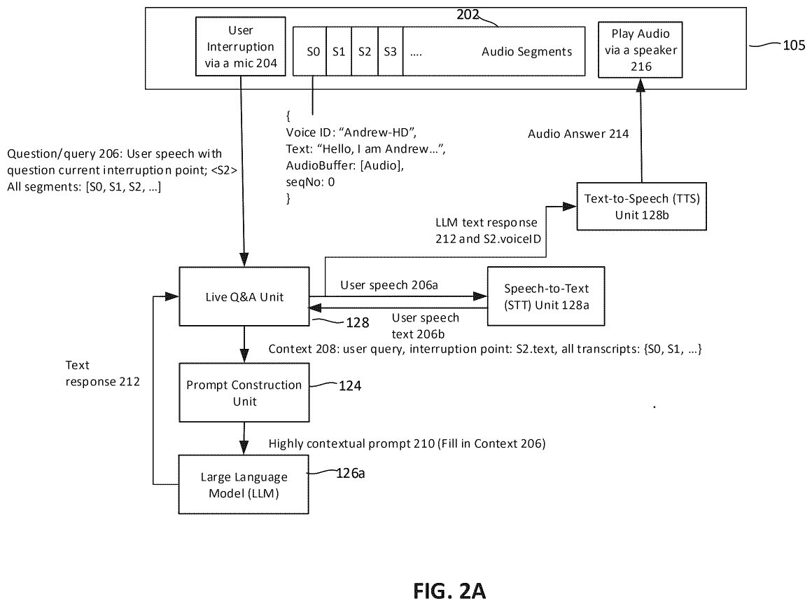

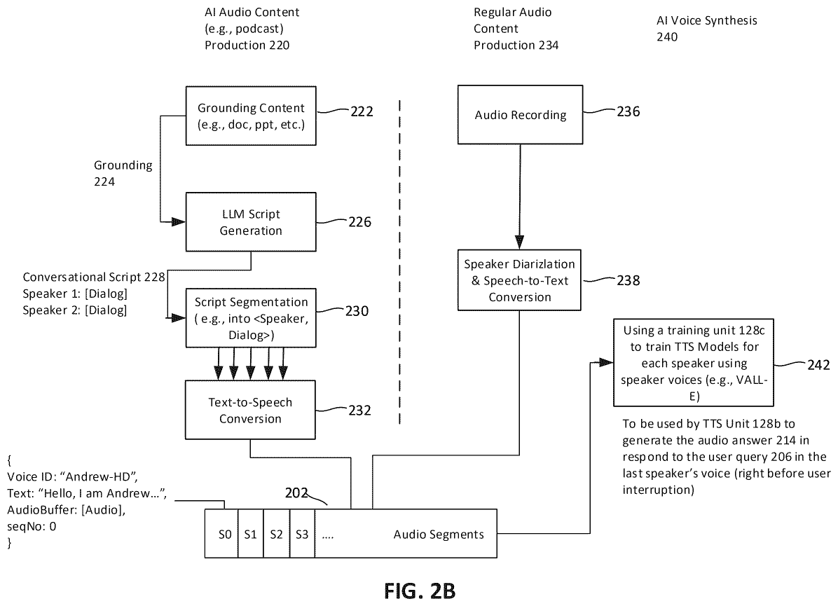

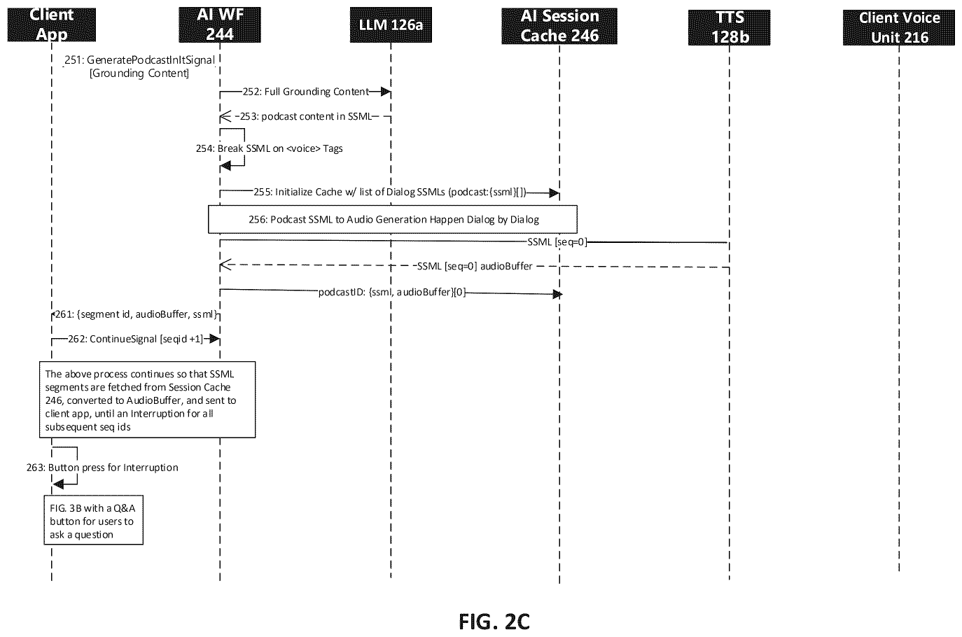

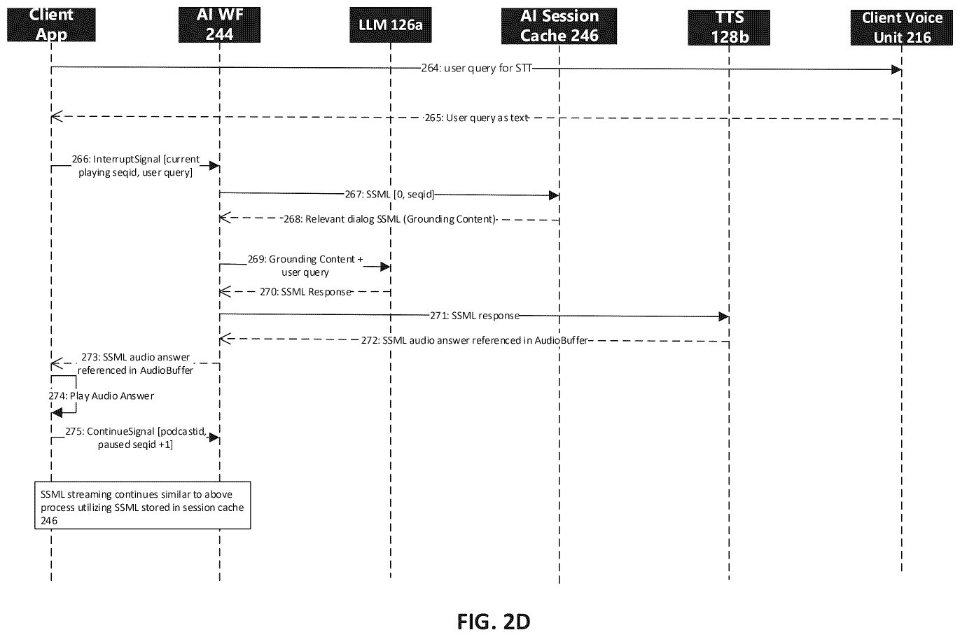

FIG. 2A is a conceptual diagram of a workflow for AI-powered contextual live Q&A when rendering pre-produced audio content of the system of FIG. 1 according to principles described herein. In FIG. 2A, the audio content 202 includes segments: [S0, S1, S2, . . . ], and each segment follows the same data format as segment <S0>: Voice ID: “Andrew-HD”, Text: “Hello, I am Andrew . . . ”, AudioBuffer: [Audio], seqNo: 0. The Voice ID “Andrew-HD” indicates the audio segment belongs to Andrew and in high definition. Andrew can be a natural person or a chatbot. The Text represents a dialog that was being spoken in text format: “Hello, I am Andrew . . . ” The AudioBuffer contains audio data of the Text: “Hello, I am Andrew . . . ” that the user hears and some sort of a sequence number.

Table 1 lists a sample podcast Q&A session. For instance, a user interrupts at a particular point by pressing a live Q&A button, which switches on a microphone 204 of the client device 105 to let the user to ask a question, and interrupts the audio content 202 (e.g., a podcast episode on marine pollution) at the segment <S2>. For example, the user query 206 is “I just wanted to understand why chemical contamination is concerning.” In Table 1. In this example, user speech 206a of the user query 206 is received a microphone of the client device 105, and then a live Q&A client application on the client device 105 bundles the user speech 206a with a current interruption point <S2> among all segments: [S0, S1, S2, . . . ] into the user query 206 to pass to the request processing unit 122 of the application services platform 110. The request processing unit 122 then passes the user query 206 to the live Q&A unit 128.

TABLE 1
Andrew: There's so much to uncover about marine pollution, and it's one of those problems
that keeps growing.
Andrew: How would you describe it in a nutshell?
Ava: Hey, Andrew. Firstly, thank you for inviting me and absolutely it's a massive
problem.
Ava: Essentially, our oceans are being flooded with two main types of pollution, chemicals
and trash.
Ava: Both are extremely harmful to marine life, the environment and even humans.
Andrew: But let's break it down a bit.
Ava: Right. And 1st let's talk about chemical pollution before that.
Andrew: I see Alex has raised his hand.
Andrew: Alex, do you want to go ahead and ask your question?
Alex: Great, Thank you.
Alex: I just wanted to understand why chemical contamination is concerning.
Ava: Well, there are a lot of reasons like health, environmental and even economic reasons.
...

First, the live Q&A unit 128 sends the user speech 206a to a speech to text (STT) unit 128a to a user speech text 206b (“S2.text”). The STT unit 128a analyzes the user speech and identifies phonemes (basic sound units) based on patterns in the audio signal. It uses machine learning models trained on large datasets of audio and transcriptions, to support real-time transcription.

Second, the live Q&A unit 128 combines the user query 206, the current interruption point <S2>, the user speech text 206b, and the transcripts of all of the segments into Context 208: user query, interruption point: S2.text, all transcripts: {S0, S1, . . . }. The live Q&A unit 128 then passes the Context 208 to the prompt construction unit 124 for constructing a prompt.

The prompt construction unit 124 generates a highly contextual prompt 210 (e.g., Table 2) based on the Context 208 embedded with the user question, the just-rendered audio segment, and the audio content transcript. The prompt 210 calls a LLM 126a to generate a contextual answer to the user question and the just-rendered audio segment, e.g., a text response 212. In short, the generative models 126 grounds on the audio content to generate a live answer. The LLM 126a sends the text response 212 to the live Q&A unit 128.

TABLE 2
export function getBargeInPrompt(bargeInRequest: BargeInRequest) {
return ‘</im_start/>system
## Role
You are a live podcast host extremely knowledgeable, friendly and great at handling your
audience.
## Situation
While you were podcasting, you were just interrupted by a member of the audience and
you have just been asked a question by the user.
#Task
You are provided with a transcript of everything that you have spoken and are about to
speak when you were interrupted by a member of audience. You will do the following:
- Using the transcript you will try your best to provide the best answer to the user, focused
more on the content you have already spoken and only dropping subtle hints of content
you're yet to speak
- Your response **MUST** answer the user's query.
- You WILL end the answer encouraging the user to hear on for more interesting content
that you are yet to speak.
- Output your response in plain text format without any formatting, simply answer the
user's question.
##Context
### All content
$(bargeInRequest.ssmlGrounding)
### Most recently spoken dialog before interruption
${bargeInRequest.currentDialog)
</im_end >
</im_start >user
$(bargeInRequest.userQuery)
</im_end > as const;
}

The live Q&A unit 128 then extract a voice ID of the speaker of the current interruption point <S2> from the respective segment, i.e., (“S2.voiceID”), and sends the text response 212 to with the voice ID of the speaker (“S2.voiceID”) to a text to speech (TTS) Unit 128b.

The TTS Unit 128b converts graphemes (letters) into phonemes (sounds) to produce natural-sounding speech. Modern TTS uses deep learning to achieve high-quality, human-like audio based actual human voice sample data. It is also possible to generate synthetic speech without human recordings by mimicking the physical properties of vocal cords and the vocal tract for a fictional character. In this case, the TTS Unit 128b (e.g., Azure® TTS) converts the text response 212 into an audio answer 214 in the voice of the speaker, and then sends the audio answer 214 to a client voice unit 216 of the client device 105 to play the audio answer 214 for the user.

FIG. 2B is a conceptual diagram of AI-powered audio content production and voice synthesis of the system of FIG. 1 according to principles described herein. There are many ways to produce the audio content 202. In one implementation of AI audio content (e.g., podcast) production 220, the system applies grounding step 224 on grounding content 222 (e.g., doc, ppt, etc.) to the LLM 126a can generate accurate and relevant podcast content. The system then call the LLM 126a to a LLM script generation step 226, and the LLM 126s generates conversational script 228 for the podcast of Speaker 1: [Dialog] and Speaker 2: [Dialog]. The system then proceeds to a script segmentation step 230 to segments the conversational script 228 into segments in a format of <Speaker, Dialog>. The system then applies the TTS unit 128b for a text-to-speech conversion step 232 per segment to generate the audio of a segment transcript (e.g., [Audio] of the Text: “Hello, I am Andrew . . . ”). As such, the system assembles per segment the relevant elements into each segment (e.g., segment <S0>: Voice ID: “Andrew-HD”, Text: “Hey everyone, welcome back to the Andrew and Emma show. I'm Andrew, and . . . ”, AudioBuffer: [Audio], seqNo: 0). The system then arranged the segments in a time sequence into the audio content 202 (e.g., a AI-generated podcast episode).

In one implementation of regular audio content production 234, the system starts with an audio recording step 236, then a speaker diarizlation and speech-to-text conversion step 238. For instance, the podcast is recorded using transitional recording mechanisms. The system applies a tool to identify and segment the podcast recording to determine when different speakers are talking, thereby assigning each audio segment to a respective speaker with labels such as Speaker 1, Speaker 2, and the like. Tools used for speaker diarization include machine learning models, clustering algorithms, and/or feature extraction from the audio to distinguish between speakers based on their voice characteristics. The system then applies the STT unit 128a to convert each audio segment into text/transcript. By analogy, the system assembles per segment the relevant elements into each segment (e.g., segment <S0>: Voice ID: “Andrew-HD”, Text: “Hello, I am Andrew . . . ”, AudioBuffer: [Audio], seqNo: 0). The system then arranged the segments in a time sequence into the audio content 202 (e.g., a recorded podcast episode).

To support AI Voice Synthesis 240 applied in FIG. 2A to generate the audio answer 214 in respond to the user query 206 in the last speaker's voice (upon user interruption), the system applies a training unit 128c of the live Q&A unit 128 to train a TTS model per each speaker using speaker voices, using for example VALL-E, F5-TTS, and the like in a TTS model training step 242.

In this case, the system assumes that the user intends to ask a question to the last speaker upon user interruption. However, when the user did not press the live Q&A timely, but later than the intended speaker, the system can apply an generative model to analyze the content of the user query 206 as directed to an earlier speaker, and switches to the earlier speaker's voice synthesis model to generate the audio answer 214.

FIGS. 2C-2D is a sequence diagram of a workflow for AI-powered audio content production and contextual live Q&A when rendering the audio content of the system of FIG. 1 according to principles described herein. The AI-powered audio content production of steps 251-262 shown in FIG. 2C is similar to the AI audio content (e.g., podcast) production 220 in FIG. 2B. In step 251, the client app (e.g., a live Q&A app residing in the client device 105) sends a request to generate a podcast episode to AI WF 244. Such AI audio content contain at least one speaker. “AI WF” stands for “Artificial Intelligence workflow,” which refers to a structured series of steps that utilize artificial intelligence technologies to automate and optimize tasks within a business process, typically involving data collection, analysis, decision-making, and action execution, aiming to improve efficiency and productivity. The request (e.g., GeneratePodcastInItSignal [Grounding Content]) to generate a podcast episode includes the grounding content 222 (e.g., doc, ppt, etc.).

In step 252, the AI WF 244 sends the grounding content 222 to the LLM 126a to generate accurate and relevant audio content 202 (e.g., a podcast episode) as detailed on the left side of FIG. 2B. In one implementation, the podcast episode is written in SSML which is an XML-based markup language designed for speech synthesis applications. SSML provides a standardized way to control and enhance the generation of synthetic speech, such as adjusting features like pronunciation, pitch, volume, speed, pauses, creating natural and expressive speech experience, and the like. SSML is supported by platforms like Azure Speech Services, Google Text-to-Speech, Alexa, and the like. In step 253, the LLM 126a sends the podcast episode back the AI WF 244.

In step 254, the AI WF 244 breaks the podcast episode is SSML per each <voice> tag as each dialog as a list of dialog SSMLs (e.g., podcastID: {ssml} [ ]). In step 255, the AI WF 244 initializes caching the list of dialog SSMLs at an AI session cache 246. At this point, the podcast SSML is produced, although not yet converted into audio signals. Table 3 lists the podcast SSML. In this implementation, the podcast SSML is converted into audio signals per dialog upon user's demand of playing the podcast. In another implementation, the full podcast SSML is converted into audio signals before user's demand of playing the podcast.

```
TABLE 3
...
  <voice name=“en-US-Andrew2:DragonHDLatestNeural”
parameters=“temperature=0.8”>Hey everyone, welcome back to the Andrew and Emma
show. I'm Andrew, and as always, I'm joined by the wonderful Emma. How's it going,
Emma?</voice>
  <voice name=“en-US-Ava:DragonHDLatestNeural”
parameters=“temperature=0.8”>Hey Andrew! I'm doing great, thanks. Excited to dive into
today's topic. How about you?</voice>
  <voice name=“en-US-Andrew2:DragonHDLatestNeural”
parameters=“temperature=0.8”>I'm good, thanks! So, today we're talking about something
pretty interesting - knowledge worker productivity. It's a bit of a mouthful, but it's super
important. You ready to get into it?</voice>
  <voice name=“en-US-Ava:DragonHDLatestNeural”
parameters=“temperature=0.8”>Absolutely! It's such a relevant topic, especially with how
work has been evolving. Let's break it down for our listeners, shall we?</voice>
  <voice name=“en-US-Andrew2:DragonHDLatestNeural”
parameters=“temperature=0.8”>Yeah, let's do that. So, knowledge workers - they're
basically people who think for a living, right? Like, their main job is to use their brains, not
their hands.</voice>
  <voice name=“en-US-Ava:DragonHDLatestNeural”
parameters=“temperature=0.8”>Exactly. And it's interesting because, unlike manufacturing
or service jobs, measuring productivity for knowledge workers isn't straightforward. It's not
like counting how many widgets you make in an hour.</voice>
  <voice name=“en-US-Andrew2:DragonHDLatestNeural”
parameters=“temperature=0.8”>Right, and that's where things get tricky. I mean, how do
you measure the productivity of someone whose job is to come up with ideas or solve
complex problems?</voice>
  <voice name=“en-US-Ava:DragonHDLatestNeural”
parameters=“temperature=0.8”>That's a great question. And that's what we're going to
explore today. There are actually six factors that influence knowledge worker productivity.
Let's start with the first one - social cohesion</voice>
  <voice name=“en-US-Andrew2:DragonHDLatestNeural”
parameters=“temperature=0.8”>Social cohesion, huh? So, basically, how well people get
along and work together?</voice>
  <voice name=“en-US-Ava:DragonHDLatestNeural”
parameters=“temperature=0.8”>Yep, that's it. It's all about the bonds of friendship, caring,
and enjoyment of each other's company. When people feel connected and comfortable,
they're more likely to share ideas and collaborate effectively.</voice>
...
<voice name=“en-US-Andrew2:DragonHDLatestNeural”
parameters=“temperature=0.8”>Well, that's all the time we have for today. Thanks for
joining us, everyone. And thank you, Emma, for such an engaging and insightful
conversation.</voice>
<voice name=“en-US-Ava:DragonHDLatestNeural”
parameters=“temperature=0.8”>Thank you, Andrew! And thanks to our listeners for tuning
in. We'll catch you next time on the Andrew and Emma show.</voice></speak>
```

In process 256, dialog SSMLs to audio generation will happen dialog by dialog upon a user request to play. In other words, the AI WF 244 reiteratively sends a dialog SSML (e.g., SSML [seq=0]) to the TTS unit 128b for conversion into an audio dialog (e.g., SSML [seq=0] audioBuffer). Upon receiving the audio dialog, the AI WF 244 bundles the audio dialog with a podcast ID as podcastID: {ssml, audioBuffer} [0] to send to the AI session cache 246 for caching.

Meanwhile, the AI WF 244 also sends another bundle of the audio dialog with the segment ID (e.g., {segment id, audioBuffer, ssml}) to the client app for playing in step 261. The client app replies to the AI WF 244 with a request for the next dialogs (e.g., ContinueSignal [seqid+1]) in step 262. The per-dialog TTS and playing process continues so that SSML segments are fetched from AI session cache 246, converted to Audio Buffer and sent to the client app, until an interruption for all subsequent seq ids.

In step 263, the user presses a button for sending a user query that causes the interruption. For example, FIG. 3B shows such a button for Q&A when playing the pre-produced audio content 202, and the user query is “how to measure bonds of friendship, caring, and enjoyment of each other's company at work?”

Continuing to FIG. 2D, after pressing of the Q&A button, the user utters a user query (e.g., the user query 206 in FIG. 2A captured by the microphone 204) to trigger a process similar to the workflow for AI-powered contextual live Q&A when rendering pre-produced audio content in FIG. 2A. In step 264, the client app sends the user query 206 to the STT unit 128a embedded in the client voice unit 216 for STT conversion into a user query text (e.g., the user speech text 206b). In step 265, the client voice unit 216 sends the user query text back to the client app. In step 266, the client app sends an interrupt signal to the AI WF 244 to interrupt/pause the playing of the podcast episode (not shown), as well as to generate an audio answer to the user query. The interrupt signal (e.g., InterruptSignal [current playing seqid, user query]) includes the current playing audio segment ID (e.g., seqid=<S2>) and the user query 206.

In step 267, the AI WF 244 sends a notification of the interrupted segment ID (e.g., SSML [0, seqid]) to the AI session cache 246. In step 268, the AI session cache 246 retrieves and send the dialog SSML corresponding to S0 to S2 as grounding content to the AI WF 244. In step 269, the AI WF 244 generates a highly contextual prompt (e.g., the prompt 210) based on the grounding Content and the user query, and sends the prompt to the LLM 126a.

In step 270, the LLM 126a generates an SSML response (e.g., the text response 212) based on the prompt, and sends the SSML response back to the AI WF 244. In step 271, the AI WF 244 forwards the SSML text response to the TTS unit 128b. In step 272, the TTS unit 128b converts the SSML text response into an SSML audio answer referenced in AudioBuffer (e.g., the audio answer 214). In step 273, the AI WF 244 forwards to the client app the SSML audio answer referenced in AudioBuffer.

In step 274, the client app plays the audio answer that considers the user query of “how to measure bonds of friendship, caring, and enjoyment of each other's company at work,” as well as the full podcast transcript regarding measuring knowledge worker productivity. For example, the audio answer 214 generated by the system is “measuring bonds of friendship, caring, and enjoyment of each other's company in the workplace to assess knowledge worker productivity involves several steps: employee surveys, observational analysis, behavioral metrics, support and resilience testing, and productivity metrics. These measurements collectively provide insights into how workplace relationships influence productivity among knowledge workers.”

In step 275, to resume the podcast content, the client app sends to the AI WF 244 a request for the dialog/segment next to the interrupted dialog/segment (e.g., ContinueSignal [podcastid, paused seqid+1]). The SSML streaming continues similar to step 262 utilizing SSML stored in the AI session cache 246. As such, the remaining SSML segments are fetched from the AI session cache 246, converted to AudioBuffer, and sent to the client app to play, until the full podcast is rendered.

In this implementation, the system includes all segment transcripts of the audio content 202: {S0, S1, . . . } in the Context 208, to provide a rich context to the user query 206. In another implementation, to accelerate the process, the system includes only segment transcripts of the audio content 202 until the interrupted segment: {S0, S1, S2} in the Context 208. For example, the dialogs before and before the dialog in Table 3: “Yep, that's it. It's all about the bonds of friendship, caring, and enjoyment of each other's company. When people feel connected and comfortable, they're more likely to share ideas and collaborate effectively.”

In another implementation, to further accelerate the process, the system includes only already rendered segment transcripts of the audio content 202: {S1, S2} in the Context 208, when the user skips or fast-forwards <S0>. In this case, since the user did not listen to <S0>, the system assumes the user's query is not relevant to <S0>. In yet another implementation, when the user query 206 includes word/phrase/concept absent from the LLM embeddings, the system can consult an external expert knowledge database.

The user can ask as many questions as possible while playing the audio content 202. For example, a subsequent user query is raised during playing other segment(s) of the audio content 202. As another example, a subsequent user query is directed to an audio answer (e.g., the audio answer 214, or any subsequent audio answer(s)). The system tracks and labels the logical sequences of Q&A during a recorded meeting by leveraging a combination of advanced technologies: automatic speech recognition, intent detection (e.g., identifying conversational cues), contextual linking (e.g., how statements relate to each other), and the like.

In some implementations, the request processing unit 122 works in conjunction with the editing unit 130 to cause the user interface to receive a comment or annotation from a user to edit the audio content, or causes the user interface to present interactive elements for the user to edit the audio content. For instance, the editing unit 130 works in conjunction with the request processing unit 122 to interact with users through a graphical user interface (GUI), providing a visual workspace for manipulating audio elements.

In addition to the explicit grounding, the workflow applies implicit grounding (e.g., via M365 Copilot®, an AI chatbot) to add additional contextual information to the grounding content in step 268. Implicit grounding refers to the ability of a generative AI model to understand and reference the real world without being explicitly programmed about it. For instance, when the user query mentions terms of concepts absent from the podcast content, the system may consults expert knowledge database for additional content.

The same workflow can be applied to AI-powered video production and contextual live Q&A when rendering the video content. The additional tasks include (1) generating/taking a video clip of the user asking a question, and (2) generating a synthetic video clip of a speaker answering the question with the highly contextual audio answer generated based on the above-discussed workflow. Such synthetic video clips can be generated using deepfake technology based on the speaker's voice and image data.

All the above-discussed content data 140 (e.g., the audio content 202, the grounding content 222, and the like), context data 142 (e.g., the Context 208), request, prompts and responses 144 (e.g., the user query 206, the user speech 206a, the user speech text 206b, the highly contextual prompt 210, the text response 212, and the like), audio answer data 146 (e.g., the audio answer 214), and other data 148 can be stored in the enterprise data storage 134. The enterprise data storage 134 can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

Since the live audio answer creation involves use of a generative AI which utilizes user content such as user/speaker voice and videos, personal data privacy and data ownership guidelines are taken into consideration. There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the example computing environment 100 can minimize the risks associated with using open source generative models while protecting enterprise data from unauthorized access or exposure.

In one example, the application services platform 110 can store enterprise data separately from generative model training data, to reduce the risk of unintentionally leaking sensitive information during model generation. The application services platform 110 can limit access to generative models and the enterprise data. The application services platform 110 can also implement proper access controls, strong authentication, and authorization mechanisms to ensure that only authorized personnel can interact with the selected model and the enterprise data.

The application services platform 110 can also run the generative models 126 in a secure computing environment. Moreover, the application services platform 110 can employ robust network security, firewalls, and intrusion detection systems to protect against external threats. The application services platform 110 can encrypt the enterprise data and any data in transit. The application services platform 110 can also employ encryption standards for data storage and data transmission to safeguard against data breaches.

Moreover, the application services platform 110 can implement strong security measures around the generative models 126, such as regular security audits, code reviews, and ensuring that the model is up-to-date with security patches. The application services platform 110 can periodically audit the generative model's usage and access logs, to detect any unauthorized or anomalous activities. The application services platform 110 can also ensure that any use of open source generative models complies with relevant data protection regulations such as GDPR, HIPAA, or other industry-specific compliance standards.

The application services platform 110 can establish data retention and data deletion policies to ensure that generated data is not stored longer than necessary, to minimizes the risk of data exposure. The application services platform 110 can perform a privacy impact assessment (PIA) to identify and mitigate potential privacy risks associated with the generative model's usage. The application services platform 110 can also provide mechanisms for training and educating users on the proper handling of enterprise data and the responsible use of generative models. In addition, the application services platform 110 can stay up-to-date with evolving security threats and best practices that are essential for ongoing data protection.

FIGS. 3A-3C are diagrams of example user interfaces of an AI-based content generation application that implements the techniques described herein. The example user interface shown in FIGS. 3A-3C is a user interface of an AI-based content generation application, such as but not limited to Microsoft Copilot®. However, the techniques herein for providing AI-powered contextual live Q&A when rendering pre-produced audio content are not limited to use in the AI-based content generation application and may be used to generate audio content for other types of applications including but not limited to presentation applications, website authoring applications, collaboration platforms, communications platforms, and/or other types of applications in which users create, play, and/or modify various types of audio content. Such applications can be a stand-alone application, or a plug-in of any application on the client device 105, such as the browser application 112, the native application 114, and the like. The system can also work within a website chat functionality.

FIG. 3A shows an example of the user interface 305 of an AI-based content generation application in which the user is interacting with an AI generative model to generate a live audio answer to a user query when rendering an audio segment of the pre-produced audio content that is just rendered or interrupted. The user interface 305 includes a control pane 315, and a chat pane 325. The user interface 305 may be implemented by the native application 114 and/or the browser application 112.

In some implementations, the control pane 315 includes an content creation button 315a, a search button 315b, and a content consumption button 315c. The content creation button 315a can be selected to provide content generation functions. For example, a user selects the content creation button 315a to create a podcast based on AI generated content or regular recorded content as discussed in FIG. 2B.

The search button 315b can be selected to provide content search functions. For example, a user selects the search button 315b to select grounding content for creating a podcast as discussed in FIG. 2B. The content consumption button 315c can be selected to provide content consumption functions. For example, a user selects the content consumption button 315c to select the generated podcast content for consumption as discussed in FIGS. 2C-2D.

In some implementations, the chat pane 325 includes a prompt enter box 325a enabling the user to enter a natural language prompt. In the example shown in FIG. 3A, the prompt enter box 325a shows “Ask me anything.” User prompts usually describe content that the user would like to have automatically generated by the generative models 126 of the application services platform 110. The application submits the natural language prompt to the application services platform 110 and user information identifying the user of the application to the application services platform 110. The application services platform 110 processes the request according to the techniques provided herein to generate audio content and/or an audio answer to a user query about a just rendered portion of the audio content according to the above discussed implementations.

In FIG. 3A, the user selects the content consumption button 315c and then a dropdown list of different audio context types, such as Podcast, Audiobook, Radio Show, and the like. The user further selects Podcast. In response, the AI chatbot displays a suggestion in box 325a shows “Sure, I've created a podcast based on a summary of your selected files. Enjoy the podcast! If you have any questions or need further assistance, feel free to ask.” in FIG. 3B.

In FIG. 3B, the user interface 305 shows a podcast content item 325b and a play status bar 325c based on the implementation described above. In this case, the user selects a Play button at the left side of the play status bar 325c to play the podcast content item 325b. There are three icons displayed below the play status bar 325c: a Volume icon, a live Q&A icon, and a Rank icon. At a timestamp 0:25, the user presses the live Q&A icon, asks a question (e.g., the query 206) via the microphone 204, and triggers an audio answer generation process depicted in FIGS. 2A and 2D. The audio answer generated based on the above-reference implementations is played to the user. The user can ask further question(s). Otherwise, the system resumes the podcast content item 325b.

In FIG. 3B, there are two buttons and two icons displayed above the podcast content item 325b: a Update button, a Publish button, a Video icon, and an audio icon. For example, the user selects the Update button and the audio icon. In response, the icons displayed below the play status bar 325c become: a Trim icon, an Add icon, and a Delete icon in FIG. 3C. When the user selects the Add icon, the system assumes the user wants to add the live user query and the audio answer into the podcast content item 325b at the timestamp 0:25 and update accordingly.

The user can then select the Publish button and the audio icon to publish the updated podcast content item. In FIG. 3C, the AI chatbot displays another suggestion in the prompt enter box 325a: “Sure, the updated podcast is ready for publishing. Where do you want to publish it?”

In some implementations, the system provides a feedback loop by augmenting thumbs up and thumbs down buttons (e.g., the Rank icon in FIG. 3B) for each audio answer in the user interface 305. If the user dislikes an audio answer, the system can ask why and use the input to improve the LLM 126a. A thumbs down click could also prompt the user to indicate whether the audio answer was too long, too short, missing key word/phase/points, and the like.

The user prompts, the content, and the user feedback are submitted to the application services platform 110 to re-generate an audio answer using the generative models 126 and/or to improve the generative models 126. The workflow for AI-powered contextual live Q&A when rendering pre-produced audio content 200 thus incorporates user feedback in real-time or in substantially real-time, and allows user edits/updates via intuitive user interfaces.

In some implementations, the application services platform 110 includes a moderation services that analyze user prompt(s), user feedbacks, and audio answers generated by the generative models 126, to ensure that potentially objectionable or offensive content is not generated or utilized by the application services platform 110. If potentially objectionable or offensive content is detected in the user prompt(s), the user feedbacks, and the audio answers, the moderation services provides a blocked content notification to the client device 105 indicating that the prompt(s), the user data is blocked from forming the system prompt. In some implementations, the request processing unit 122 discards any user query that includes potentially objectionable or offensive content and passes any remaining content that has not been discarded to the request processing unit 122 to be provided as an input to the prompt construction unit 124. In other implementations, the prompt construction unit 124 discards any content that includes potentially objectionable or offensive content and passes any remaining content that has not been discarded to the generative models 126 as an input.

As discussed, the moderation services generates a blocked content notification in response to determining that the user queries, and/or the system prompt includes potentially objectionable or offensive content, and the notification is provided to the native application 114 or the browser application 112 so that the notification can be presented to the user on the client device 105. For instance, the user may attempt to revise and resubmit the user queries. As another example, the system may generate another system prompt after removing task data associated with the potentially objectionable or offensive content. The moderation services can be implemented by a machine learning model trained to analyze the content of these various inputs and/or outputs to perform a semantic analysis on the content to predict whether the content includes potentially objectionable or offensive content (e.g., language/image/sound).

As mentioned, the application services platform 110 complies with privacy guidelines and regulations that apply to the usage of user data included in the content to be summarized in a video to ensure that users have control over how the application services platform 110 utilizes their data. The user is provided with an opportunity to opt into the application services platform 110 to allow the application services platform 110 to access the user data and enable the generative models 126 to generate an audio answer to a user query about a just rendered portion of the audio content according to user consent. In some implementations, the first time that an application, such as the native application 114 or the browser application 112 presents the data analysis assistant to the user, the user is presented with a message that indicates that the user may opt into allowing the application services platform 110 to use user data included in the content to support the live Q&A functionality. The user may opt into allowing the application services platform 110 to access all or a subset of user data included the user's voice and/or images to be synthesized in an audio and/or video clip. Furthermore, the user may modify their opt-in status at any time by selectively opting into or opting out of allowing the application services platform 110 from accessing and utilizing user data from the content as a whole or individually.

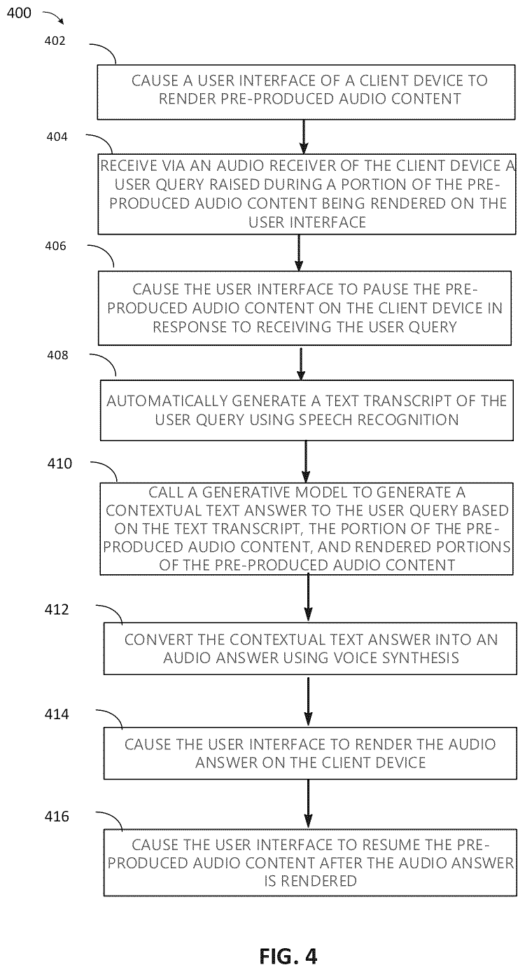

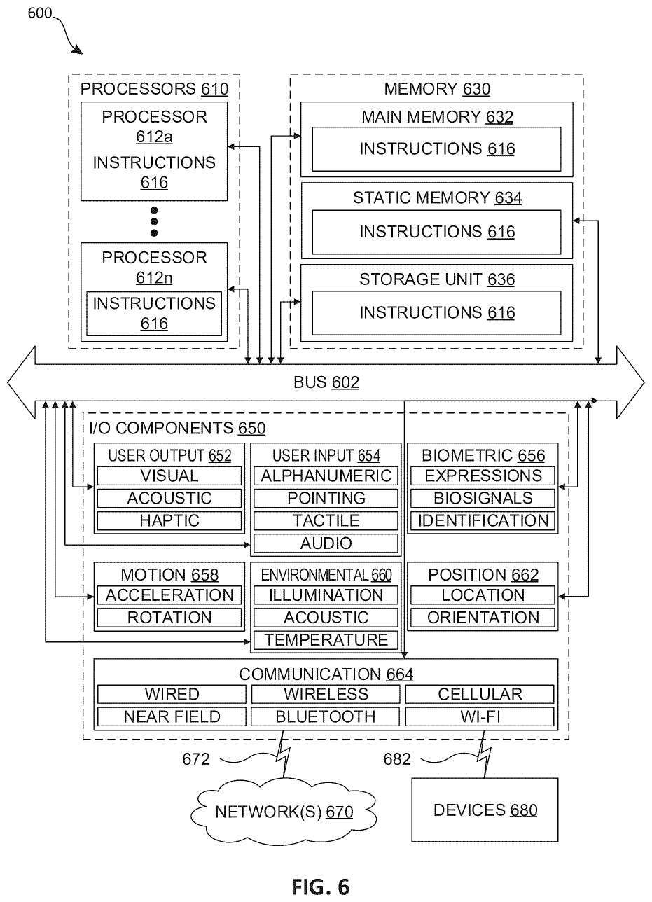

FIG. 4 is a flow chart of an example process for providing AI-powered contextual live Q&A when rendering pre-produced audio content according to the techniques disclosed herein. The process 400 can be implemented by the application services platform 110 or its components shown in the preceding examples. The process 400 may be implemented in, for instance, the example machine including a processor and a memory as shown in FIG. 6. As such, the application services platform 110 can provide means for accomplishing various parts of the process 400, as well as means for accomplishing implementations of other processes described herein in conjunction with other components of the example computing environment 100. Although the process 400 is illustrated and described as a sequence of steps, it is contemplated that various implementations of the process 400 may be performed in any order or combination and need not include all the illustrated steps.

In one implementation, for example, in step 402, a request processing unit (e.g., the request processing unit 122) causes a user interface (e.g., the user interface 305 in FIGS. 3A-3C) of a client device (e.g., the client device 105) to render pre-produced audio content (e.g., the audio content 202). For example, the pre-produced audio content include at least one of a podcast episode, an audiobook, a radio show, a voiceover in a film, advertisement, or video game, a recorded lecture, a recorded lesson, an audio drama, a recorded interview, or a recorded panel discussion.

In step 404, the request processing unit receives via an audio receiver (e.g., the microphone 204) of the client device a user query (e.g., the user query 206, “I just wanted to understand why chemical contamination is concerning” in Table 1, and the like) raised during a portion of the pre-produced audio content (e.g., <S2>, “Right. And 1st let's talk about chemical pollution before that” in Table 1, and the like) being rendered on the user interface. In step 406, the request processing unit causes the user interface to pause the pre-produced audio content on the client device in response to receiving the user query.

In step 408, an speech-to-text unit (e.g., the STT unit 128a of the live Q&A unit 128) automatically generates a text transcript of the user query using speech recognition. The speech recognition is implemented via at least one AI model, and the at least one AI model (e.g., Azure STT®, OpenAI Whisper®, DeepSpeech®, and the like) includes a generative model or a machine learning model.

In step 410, the prompt construction unit 124 calls a generative model (e.g., the LLM 126a) to generate a contextual text answer (e.g., the text response 212, “measuring bonds of friendship, caring, and enjoyment of each other's company in the workplace to assess knowledge worker productivity involves several steps: employee surveys, . . . , and the like) to the user query based on the text transcript of the user query, the portion of the pre-produced audio content (e.g., <S2>), and at least rendered portions of the pre-produced audio content (e.g., <S0>, <S1>). In another implementation, the generative model to generate a contextual text answer based on the full audio content (e.g., <S0>, <S1>, <S2>, <S3>, . . . ), to make the audio answer richer. For example, the generative model is a language model (e.g., the LLM 126a, or OpenAI RealTime Voice API integrated with OpenAI's LLMs) or a multimodal model (e.g., the LMM 126b). In another implementation, the generative model is a the LVM 126c (e.g., Sora) to handle video answer generation.

In step 412, a text-to-speech unit (e.g., the TTS unit 128b of the live Q&A unit 128) converts the contextual text answer into an audio answer (e.g., the audio answer 214) using voice synthesis. The voice synthesis is implemented via at least one AI model (e.g., Azure TTS®, ElevenLabs®, Voicebox®, Coqui TTS®, and the like), and the at least one AI model includes a generative model or a machine learning model.

In step 414, the request processing unit causes the user interface to render the audio answer on the client device. In step 416, the request processing unit causes the user interface to resume the pre-produced audio content after the audio answer is rendered

In one implementation, the live Q&A unit 128 extracts from metadata of the pre-produced audio content a voice identifier (e.g., “S2.voiceID”), of a speaker of the portion of the pre-produced audio content just rendered or interrupted. The contextual text answer is converted into the audio answer using a pre-trained voice synthesis generative model associated with the voice identifier. For instance, a training unit (e.g., the training unit 128c of the live Q&A unit 128) samples voice data of the speaker, and uses the voice data of the speaker to train a generative model into the pre-trained voice synthesis generative model (in the VALL-E).

In some implementations, the request processing unit causes the user interface to continuing pausing the pre-produced audio content on the client device, when receiving a subsequent user query directed to (1) the audio answer (e.g., the audio answer 214, “measuring bonds of friendship, caring, and enjoyment of each other's company in the workplace to assess knowledge worker productivity involves several steps: employee surveys, . . . , and the like”), and/or (2) another portion of the pre-produced audio content subsequent to the portion just rendered or interrupted (e.g., “So, if your boss is constantly criticizing you and not recognizing your hard work, you're not going to be very motivated, right?”). The subsequent user query is received via the audio receiver (the microphone 204) of the client device. When the subsequent user query is directed to (1) the audio answer, the STT unit 128a generates a text transcript of the subsequent user query using speech recognition.

The prompt construction unit 124 then calls the generative model (e.g., the LLM 126a) to generate a subsequent contextual text answer to the subsequent user query based on the text transcript of the subsequent user query, as well as the contextual text answer and/or the another portion of the pre-produced audio content. The TTS unit 128b converts the subsequent contextual text answer into a subsequent audio answer using voice synthesis. The request processing unit causes the user interface to render the subsequent audio answer on the client device, and then causes the user interface to resume the pre-produced audio content after the subsequent audio answer is rendered.

In one implementation, the editing unit 130 inserts the user query and the audio answer to an end of the portion of the pre-produced audio content just rendered or interrupted as an updated pre-produced audio content (e.g., as referenced in FIG. 3C). The request processing unit causes the user interface to receive a confirmation of the updated pre-produced audio content from a user that provides the user query, and then causes a publication of the updated pre-produced audio content.

In one implementation, the request processing unit receives, via the client device, digital content (e.g., Grounding Content like doc, ppt, etc. in FIG. 2B) and a request to a generative model to generate the pre-produced audio content (e.g., see step 251 in FIG. 3C: the live Q&A app residing in the client device 105 sends a request to generate a podcast episode to AI WF 244). For example, the digital content includes any of text, audio, or video. The prompt construction unit 124 then calls the generative model (e.g., the LLM 126a) or another generative model (e.g., the LMM 126b) to generate the pre-produced audio content based on the digital content and the request. Specifically, the prompt construction unit constructs a first prompt by appending the digital content to a first instruction string, the first instruction string including instructions to the generative model to identify semantic context of the digital content based on metadata of the digital content, to identify at least one of a text data item, an audio data item, or a video data item embedded in the digital content to generate a text transcript of the audio data item, a text transcript of the video data item, or a textual description of the video data item, and to generate the pre-produced audio content based on at least one of the text data item, the text transcript of the audio data item, a text transcript of the video data item, or the textual description of the video data item. The request processing unit receives the pre-produced audio content from the generative model, and provides the pre-produced audio content to play at the client device.

By analogy, the workflow can be applied to any pre-produced serially consumable digital content to offer live Q&A multimedia sessions when rendering the digital content. For example, a user can create a PowerPoint® deck into a multimedia digital content that include audio, video, slide content, and the like. Another example includes converting a Word document to consumable multimedia. With the live Q&A functionality that leverages the context of the multimedia digital content being presented in proximity to the portion just rendered and the user query, the system can generate a multimedia answer to a user query raised during a portion of the pre-produced digital content being rendered on the user interface.

Therefore, the system can assist users to generate a live audio answer to a user query when rendering an audio segment of the pre-produced audio content that is just rendered or interrupted, via a chat interface. Such interactive, chat-based Q&A of the digital content can help a user to quickly understand the digital content. In particular, the system supports generating effective system prompts with extracted text/audio summary data from different content components, and such system prompts are clear, concise, and provide enough context for the generative models to generate an audio answer to a user query about a just rendered portion of the digital content. In addition, the system provides users interactive tools to change/refine the digital content updated with the Q&A clips, and then share/publish the updated digital content.

For example, the system uses generative AI to give users a power to have live conversations while listening to a produced audio content (e.g., podcast). As such, the podcast is not just a unidirectional flow of information, it also supports engaging conversation (e.g., Q&A). The entire communication flow continues as if the podcast continues playing with the interruption/plug-in point when the user had paused for asking question(s) that questions got answered. The user did not lose track of the questions since the user did not need to note the questions or answers.

The detailed examples of systems, devices, and techniques described in connection with FIGS. 1-4 are presented herein for illustration of the disclosure and its benefits. Such examples of use should not be construed to be limitations on the logical process implementations of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some implementations, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In implementations in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

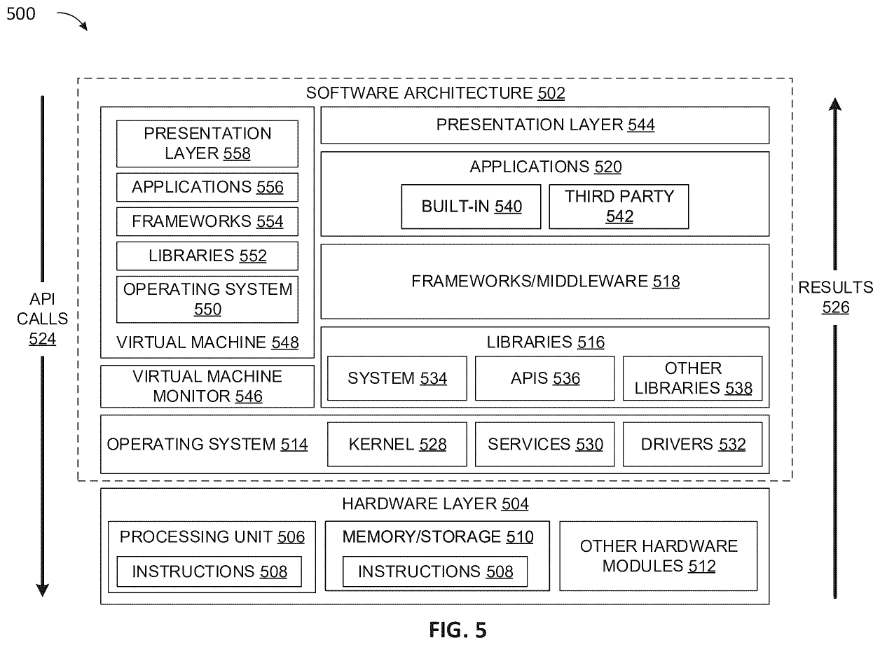

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. The executable instructions 508 held by processing unit 506 may be portions of the executable instructions 508 held by the memory/storage 510.

The example software architecture 502 may be conceptualized as layers, each providing various functionality. For example, the software architecture 502 may include layers and components such as an operating system (OS) 514, libraries 516, frameworks/middleware 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks/middleware 518 (also sometimes referred to as middleware) provide a higher-level common infrastructure that may be used by the applications 520 and/or other software modules. For example, the frameworks/middleware 518 may provide various graphic user interface (GUI) functions, high-level resource management, or high-level location services. The frameworks/middleware 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks/middleware 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a neural processing unit (NPU), a tensor processing unit (TPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a machine-readable storage medium storing executable instructions that, when executed, cause the processor alone or in combination with other processors to perform operations of:
causing a user interface of a client device to render pre-produced audio content;
receiving via an audio receiver of the client device a user query raised during a portion of the pre-produced audio content being rendered on the user interface;
causing the user interface to pause the pre-produced audio content on the client device in response to receiving the user query;
automatically generating a text transcript of the user query using speech recognition;
calling a generative model to generate a contextual text answer to the user query based on the text transcript of the user query, the portion of the pre-produced audio content, and at least rendered portions of the pre-produced audio content;
converting the contextual text answer into an audio answer using voice synthesis;
causing the user interface to render the audio answer on the client device; and
causing the user interface to resume the pre-produced audio content after the audio answer is rendered.

2. The data processing system of claim 1, wherein the machine-readable storage medium further includes instructions configured to cause the processor alone or in combination with other processors to perform operations of:
extracting from metadata of the pre-produced audio content a voice identifier of a speaker of the portion of the pre-produced audio content,
wherein the contextual text answer is converted into the audio answer using a pre-trained voice synthesis generative model associated with the voice identifier.

3. The data processing system of claim 2, wherein the machine-readable storage medium further includes instructions configured to cause the processor alone or in combination with other processors to perform operations of:
sampling voice data of the speaker; and
using the voice data of the speaker to train a generative model into the pre-trained voice synthesis generative model.

4. The data processing system of claim 1, wherein the machine-readable storage medium further includes instructions configured to cause the processor alone or in combination with other processors to perform operations of:
causing the user interface to continue pausing the pre-produced audio content on the client device, when receiving a subsequent user query directed to at least one of the audio answer, or another portion of the pre-produced audio content subsequent to the portion, wherein the subsequent user query is received via the audio receiver of the client device;
automatically generating a text transcript of the subsequent user query using speech recognition;
calling the generative model to generate a subsequent contextual text answer to the subsequent user query based on the text transcript of the subsequent user query, and at least one of the contextual text answer or the another portion of the pre-produced audio content;
converting the subsequent contextual text answer into a subsequent audio answer using voice synthesis; causing the user interface to render the subsequent audio answer on the client device; and
causing the user interface to resume the pre-produced audio content after the subsequent audio answer is rendered.

5. The data processing system of claim 1, wherein the pre-produced audio content include at least one of a podcast episode, an audiobook, a radio show, a voiceover in a film, advertisement, or video game, a recorded lecture, a recorded lesson, an audio drama, a recorded interview, or a recorded panel discussion.

6. The data processing system of claim 1, wherein the machine-readable storage medium further includes instructions configured to cause the processor alone or in combination with other processors to perform:
inserting the user query and the audio answer to an end of the portion of the pre-produced audio content as an updated pre-produced audio content.

7. The data processing system of claim 6, wherein the machine-readable storage medium further includes instructions configured to cause the processor alone or in combination with other processors to perform operations of:
causing the user interface to receive a confirmation of the updated pre-produced audio content from a user that provides the user query; and
causing a publication of the updated pre-produced audio content.

8. The data processing system of claim 1, wherein the speech recognition or the voice synthesis is implemented via at least one artificial intelligence model, and the at least one artificial intelligence model includes a generative model or a machine learning model.

9. A method comprising:
causing a user interface of a client device to render pre-produced serially consumable digital content, wherein the digital content includes video content and audio content;
receiving via a an audio receiver of the client device a user query raised during a portion of the pre-produced digital content being rendered on the user interface;
causing the user interface to pause the pre-produced digital content on the client device in response to receiving the user query;
automatically generating a text transcript of the user query using speech recognition;
calling a generative model to generate a contextual text answer to the user query based on the text transcript of the user query, the portion of the pre-produced digital content, and at least rendered portions of the pre-produced digital content;
converting the contextual text answer into a multimedia answer using voice and image synthesis;
causing the user interface to render the multimedia answer on the client device; and
causing the user interface to resume the pre-produced digital content after the multimedia answer is rendered.

10. The method of claim 9, further comprising:
extracting from metadata of the pre-produced digital content a voice identifier and an image identifier of a speaker of the portion of the pre-produced digital content,
wherein the contextual text answer is converted into the multimedia answer using a pre-trained voice and image synthesis generative model associated with the voice identifier and the image identifier.

11. The method of claim 10, further comprising:
sampling voice and image data of the speaker; and
using the voice and image data of the speaker to train a generative model into the pre-trained voice and image synthesis generative model.

12. The method of claim 9, further comprising:
causing the user interface to continue pausing the pre-produced digital content on the client device, when receiving a subsequent user query directed to at least one of the multimedia answer, or another portion of the pre-produced digital content subsequent to the portion, wherein the subsequent user query is received via the audio receiver of the client device;
automatically generating a text transcript of the subsequent user query using speech recognition;
calling the generative model to generate a subsequent contextual text answer to the subsequent user query based on the text transcript of the subsequent user query, and at least one of the contextual text answer or the another portion of the pre-produced digital content;
converting the subsequent contextual text answer into a subsequent multimedia answer using voice and image synthesis;
causing the user interface to render the subsequent multimedia answer on the client device; and
causing the user interface to resume the pre-produced digital content after the subsequent multimedia answer is rendered.

13. The method of claim 9, further comprising:
inserting the user query and the multimedia answer to an end of the portion of the pre-produced digital content as an updated pre-produced digital content.

14. The method of claim 9, further comprising:
causing the user interface to receive a confirmation of the updated pre-produced digital content from a user that provides the user query; and
causing a publication of the updated pre-produced digital content.

15. The method of claim 14, wherein the speech recognition or the voice and image synthesis is implemented via at least one artificial intelligence model, and the at least one artificial intelligence model includes a generative model or a machine learning model.

16. A non-transitory computer readable medium on which are stored instructions that, when executed, cause a programmable device to perform functions of:
causing a user interface of a client device to render pre-produced audio content;
receiving via an audio receiver of the client device a user query raised during a portion of the pre-produced audio content being rendered on the user interface;
causing the user interface to pause the pre-produced audio content on the client device in response to receiving the user query;
automatically generating a text transcript of the user query using speech recognition;
calling a generative model to generate a contextual text answer to the user query based on the text transcript of the user query, the portion of the pre-produced audio content, and at least rendered portions of the pre-produced audio content;
converting the contextual text answer into an audio answer using voice synthesis;
causing the user interface to render the audio answer on the client device; and
causing the user interface to resume the pre-produced audio content after the audio answer is rendered.

17. The non-transitory computer readable medium of claim 16, wherein the instructions when executed, further cause the programmable device to perform:
extracting from metadata of the pre-produced audio content a voice identifier of a speaker of the portion of the pre-produced audio content,
wherein the contextual text answer is converted into the audio answer using a pre-trained voice synthesis generative model associated with the voice identifier.

18. The non-transitory computer readable medium of claim 17, wherein the instructions when executed, further cause the programmable device to perform:
sampling voice data of the speaker; and
using the voice data of the speaker to train a generative model into the pre-trained voice synthesis generative model.

19. The non-transitory computer readable medium of claim 16, wherein the instructions when executed, further cause the programmable device to perform:
causing the user interface to continue pausing the pre-produced audio content on the client device, when receiving a subsequent user query directed to at least one of the audio answer, or another portion of the pre-produced audio content subsequent to the portion, wherein the subsequent user query is received via the audio receiver of the client device;
automatically generating a text transcript of the subsequent user query using speech recognition;
calling the generative model to generate a subsequent contextual text answer to the subsequent user query based on the text transcript of the subsequent user query, and at least one of the contextual text answer or the another portion of the pre-produced audio content;
converting the subsequent contextual text answer into a subsequent audio answer using voice synthesis;
causing the user interface to render the subsequent audio answer on the client device; and
causing the user interface to resume the pre-produced audio content after the subsequent audio answer is rendered.

20. The non-transitory computer readable medium of claim 16, wherein the instructions when executed, further cause the programmable device to perform:
inserting the user query and the audio answer to an end of the portion of the pre-produced audio content as an updated pre-produced audio content.
